(19) United States
(12) Patent Application Publication
(10) Pub. No.: US 2007/0056939 A1
(43) Pub. Date: Mar. 15, 2007

(54) Method for laser cladding of tubes

(76) Inventors: Paul T. Colby, New Castle, PA (US); Paul N. Colby, Bodgega Bay, CA (US)

Correspondence Address: LEV INTELLECTUAL PROPERTY CONSULTING, 4766 MICHIGAN BOULEVARD, YOUNGSTOWN, OH, 44505, US

(21) Appl. No.: 11/496,699

(22) Filed: Jul. 31, 2006

Related U.S. Application Data
(63) Continuation of application No. 60/715,663, filed on Sep. 9, 2005.

(51) Int. Cl. B23K 26/34

(52) U.S. Cl. 219/121.63; 219/121.64

(57) ABSTRACT

A system and process is provided for cladding of cylindrical surfaces. The cladding operation uses a laser head to carry out a welding operation in a tube spinning at high speeds to create smoother interior and exterior linings than can be obtained with conventional welding techniques. As a result, substantial post-weld machining and finishing are eliminated.

### TECHNICAL FIELD

The present invention relates generally to the field of internal cladding of various tube-like components, such as barrels used for extruding plastic, engine cylinders, pipes for oil, gas, mining and gun barrels. In particular, the present invention is directed to a system for faster, more efficient internal cladding of barrels, or other cylindrical objects, both internally and externally.

### BACKGROUND ART

The technologies directed to the internal and external cladding of tube-like structures, such as metal barrels, have become substantially advanced. This is especially true for the manufacture of plasticating barrels. These are barrels used with screws to extrude plastic resin used for injection molding. A comprehensive consideration of the cladding art can be found by a consideration of manufacturing techniques for plasticating barrels.

Extruders and tubers (rubber extruders) have been in use at least since the beginning of the twentieth century. With the advent of plastics, the demand for such extruders has become greater, and the processing conditions have become more severe. Originally such devices were essentially a simple screw rotating inside a single-material barrel without a lining. This is no longer acceptable due to the newer and more difficult to process materials, such as polymer resins.

Both barrels and screws are subject to wear from metal-to-metal contact, and from abrasive and corrosive fillers in the plastic or rubber compounds. The original barrels sometimes had internal surfaces that were nitrated to give improved abrasive wear resistance. In the later 1950's bimetallic barrels were developed using a centrifugal casting process, as briefly described in the Spirex publication entitled Plasticating Components Technology, 1997, incorporated herein by reference. Also, such improved barrels were adapted for use with injection molding machines, in addition to conventional extruders.

Centrifugal casting of plasticating barrels is a conventional process used to line the internal surface of a barrel with an abrasion and/or corrosion resistant liner that is different from the barrel backing material or substrate. The process involves installing a lining material, such as a powder, inside the heavy-walled barrel cylinder at room temperature. The ends of the barrel are capped (usually welded) and the barrel and unmelted powder are placed in a casting oven. The barrel is then rotated and heated until the liner material metals are melted uniformly distributed on the internal surface of the barrel. Early liner materials were iron/boron materials that created some metal carbides and were very much more wear resistant than the nitrited barrels. In 1968 improved liners became more abrasion resistant by the addition of very small, discrete metal carbides particles like tungsten carbide and equivalent materials. However, this proved to be a delicate process having certain complications.

Most rotational casting ovens are gas heated, but some are induction heated. In either case, the inside of the barrel must be heated to a point where the liner powder melts, but the thick-walled barrel material or substrate does not melt. After melting is accomplished the barrel is slowly cooled so that stresses are not induced, and so that the liner material does not crack. After cooling, the barrel is honed, straightened and machined to its final dimensions. Often this requires installation of a high-pressure sleeve at the discharge end of the barrel.

There are a number of disadvantages to this technique. Gas-fired or induction furnaces used with rotating equipment are very expensive, and require extensive maintenance. This include periodic and prolonged shutdowns to reline the refractory surfaces of the oven. Further, even when the furnaces are functioning properly, set up for the coating of each barrel is an awkward and time-consuming process

Also, the process of centrifugal coating requires that the liner material or material matrix melt at a lower temperature than the backing or substrate material. This creates severe limitations on the liner materials than can be used. As a result, abrasion-resistant and corrosion-resistant materials are limited to formulas that melt at a lower temperature than the barrel substrate. In many cases the optimum barrel substrate and other substrates or backing under materials cannot be used. There is also the requirement of raising the backing or substrate material to a temperature close to the melting point of the substrate material followed by a slow cooling to anneal it to the lining material. This lowers the strength of the annealed backing material. Unfortunately, in modern injection molding systems very high strengths are now required because such barrels can be subject to internal pressures of 40,000 psi or higher, and the temperature up to 700 deg.F. These conditions usually require the installation of a high pressure sleeve at considerable expense. Some newer, higher priced alloys can reduce this effect somewhat by reducing the loss of strength. However, much greater expense is incurred.

Further, during the rotational casting process the heavier metal carbide particles tend to be thrown outward by centrifugal force. This moves these particles away from the inside surface where they are needed for abrasion resistance. As a result, the lining is far more susceptible to wear caused by resin abrasion than if the metal carbide particles are properly located on the inner surface of the lining or evenly distributed throughout the lining or cladding.

The high barrel temperatures that are reached during casting make it difficult to maintain the straightness of the barrel, which is critical to movement of the screw during the plastic molding operation. Straightening of the barrel cannot be done by conventional straightening presses because reverse bending cracks the thin relatively brittle liner. Further, the rotational casting process requires a substantial time to heat the liner and barrel substrate. Additional time is required for slow cooling after the lining operation. This causes added expense in labor and electrical costs.

Because the lining process can only be successful in a very narrow range of time and temperatures, often the results are not satisfactory. High temperatures and long time periods spent at these temperatures cause dilution of the liner by migration of the substrate material into the barrel lining material. This causes questionable hardness and poor abrasion resistance. Also substrate migration of the base iron material can cause poor corrosion resistance in certain applications. Extended periods at high temperatures also cause the discrete metal carbide particles coating the liner inner surface to melt into solution in the matrix matter (constituting the liner) rendering them useless.

When temperatures are too low and the time periods at properly elevated temperatures are too short, an inadequate metallic bond can result. Such an inadequate metallic bond means that the liner may become separated from the barrel substrate or backing material. This condition could render the entire barrel useless. Further, in some cases portions of the liner may come dislodged, corrupting the molten plastic and/or fouling the screw pushing the molten plastic through the barrel. In either case, the barrel is subject to catastrophic failure, and the plastic processed therein ruined.

Conventional MIG or TIG welding of the inside diameter (ID) of barrels can be done, but it is more difficult to get into smaller diameter barrels. The zone affected by heat is much greater, and the welded surface is poor. Conventional welding leaves a very irregular surface, very often 0.1 inch or more. Further, the “wave” pattern that is left is irregular in the pattern of peaks and valleys. This requires a great deal of mechanical machining in order to put the surface in proper condition for use. If this machining must take place on the interior of a tube or barrel, it can be extremely awkward.

A different method of producing barrel liners is constituted by cladding using laser welding. Laser cladding is laser welding of a different surface material onto the base or substrate metal of the tube. This process diminishes or eliminates many all of the disadvantages listed above, and is applicable for exterior as well as interior of tube-like structures.

Laser welding of the ID of barrels involves the depositing of a liner material prior to welding in the form of paste or powder, or a separate liner tube. In the alternative, during this welding process a powder or continuous wire is applied to the surface receiving the lining. The laser welder usually includes a laser beam delivered from a remote source via fiber optics and optical systems, or by direct laser beams.

This technique has a number of advantages. For example, devices have been made that will allow laser welding into diameters as small as ¾ inch. Laser cladding also has a very shallow heat-affected depth, which gives much less dilution of the liner material into the barrel substrate. This technique also creates much less stress in the substrate, reducing the tendency to bend or warp.

Laser cladding is a relatively robust process that allows for a wide latitude of materials to be used, including materials that melt at higher temperatures than the barrel substrate. This can lead to improved matrix materials and improved ceramic or carbide materials as anti-abrasive coatings on the liner. The particles can more easily be evenly distributed where they are needed.

The substrate does not necessarily need to be preheated prior to welding, thus reducing production time and expense. Heat imparted by the laser welding process is much reduced and can be removed during welding by either internal or external methods. This means that a long cooling down time can be eliminated. As a result, the process is less time-consuming than centrifugal casting.

Laser welding is an actual welding process with a metallurgical bond rather than a brazing process where the liner melts at a lower temperature than the substrate, as is the case with rotational casting. The laser cladding equipment is generally lower cost than gas-fired or induction furnaces.

Several systems to laser clad the insides of pipes have been developed and commercialized. These include EPRI Patent Nos. 5,653,897 and 5,656,185 and IHI Patent No. 5,426,278. Also included are U.S. Pat. Nos. 5,496,422; 5,196,272; and, 5,387,292. All of the aforementioned patents are incorporated herein by reference to facilitate a better understanding of the present invention.

These systems are designed to repair damaged or corroded heat exchanger tubes in power generation plants. This is done by making short, localized repairs in relatively long, fixed pipes, that cannot rotate. Each of these systems uses a rotating laser head for welding.

The systems described in the aforementioned patents include the insertion of a cladding or inlay material by any of a wire, powder, paste, or thin wall tube. The paste and the tubes must already be in place before the laser cladding operation. In the case of the EPRI patent, a coiled wire is placed inside the pipe directly above the repair area in order to have it easily accessible and easy to feed as the cladding proceeds. This method is limited to short, longitudinal weld lengths as is generally required in boiler repair. Powder is difficult to introduce in the vertical position without gravity assist since it tends to clog and interrupt the cladding process.

For prolonged or full-length cladding of 20:1 L/D or longer pipes, the head and especially the reflecting mirrors must be cooled. This can be done using a cooling fluid such as air or water. The EPRI patents do not include such cooling features, except for the bearings that are required to rotate the head inside the pipe. The IHI device allows cooling (by air) coming from the direction of the laser source.

All of these devices must have auxiliary services introduced from the laser head end of the tube because access from the opposite end is not available, and cannot be coordinated with the activity provided from the laser end. These auxiliary services can include a fiber optical viewer, wire/powder feeds, cooling media, optics (lenses) and focusing devices.

The devices disclosed in the subject patents weld on constantly changing surfaces. This tends to give a non-uniform and less smooth surface due to the influence of gravity. If the cladding is done with the pipe in a vertical position, the melt pool tends to not be flattened and can have exaggerated rings or other distortions in the surface. In any case, there is no natural tendency to flatten or smooth the surface in a uniform manner.

Also, materials currently used in conventional laser welding processes are used primarily for corrosion resistance. This limited application of the conventional technology is adequate for boilers since the boiler tubes (in which conventional laser welding occurs) are not exposed to the abrasion of the types of materials handled by plasticating barrels. Consequently, many conventional techniques are unsuitable for cladding plasticating barrels.

One major difference between cladding boiler tubes and cladding plasticating barrels is that in many cases the plasticating barrels are much smaller. There is also a need to make such devices smaller than the standard commercial sizes now available. For example, barrel I.D.'s as small as 14 mm (0.551 inch) are used for plasticating barrels. Thus, appropriate welding devices are necessary to clad or line the interior of the plasticating barrels. Consequently, welding irregularities of 0.1 inch or even 0.05 inch become unacceptable. Likewise, the wave-like surface produced by welding techniques can create insurmountable problems within very narrow tubes.

Conventional rotating welding devices operate entirely from one end of the tube being lined or welded. Consequently, size reduction for such welding devices is severely limited. This is particularly true since the welding head must include all auxiliary services, as well as the bearings for rotating. This entire structure is fed into the tube to be welded from only one side of the tube. As a result, size reduction of the overall welding apparatus is very problematical, and cannot accommodate some smaller sizes used for plasticating barrels.

One solution has been found in U.S. Pat. No. 6,486,432, issued Nov. 26, 2002 to the same inventors of the present invention, and entitled METHOD FOR LASER CLADDING OF PLASTICATING BARRELS. This patent discloses a system and process for cladding the interiors of plasticating barrels, or any other interior surface. The subject cladding system uses a moving laser head that carries out a spiral welding technique to create a smoother lining than can be done with conventional welding techniques.

A number of different techniques can be used, including the use of feeding laser energy at one end of the tube to be reflected from laser-optics inserted into a second end of the tube. Unidirectional welding can operate to facilitate gravity as a smoothing agent. In another embodiment, unidirectional welding can be carried out using a shaped mirror and a donut-shaped laser pattern. The cladding operation can be facilitated by baking a coating of the welding matrix and anti-abrasive material onto the interior of the surface to be clad prior to the welding operation.

The result is a much smoother surface than has been obtainable with prior welding systems. The ridges and valleys that result from the laser cladding process are largely uniform throughout the cladding. The differences between the hills and the valleys, is limited and indicates little variation. As a result, a barrel so clad requires far less post-cladding finishes than is necessary with previous welding-cladding systems. This is especially crucial when finishing a cladded surface within the interior of a relatively thin tube or plasticating barrel.

Unfortunately, the interior surface achieved by the subject patent, while superior to that of prior systems, is not perfect. For example, there is approximately 0.05 inch between the high points of the ridges and the low points of the valleys created by the aforementioned laser welding, which uses an overlapping weld bead. As a result, substantial post-weld machining is still necessary. Even if far less machining is needed than with previous systems, this is still expensive and time-consuming.

Accordingly, there is a need for a system that maintains all of the advantages of U.S. Pat. No. 6,486,432 while overcoming its deficiencies. Out of necessity, such a system would have to be flexible and capable of using a number of different techniques to produce an optimum product at lowered costs. The final product would be essentially free of the necessity of substantial post-welding machining or finishing.

### SUMMARY OF THE INVENTION

It is one object of the present invention to provide a system for lining or cladding tubes or any tube-like surface that overcomes the drawbacks of the conventional art.

It is another object of the present invention to provide a system for cladding inside diameters (I.D.) and exteriors of tube-like structures, that is sufficiently flexible so that a wide variety of tube sizes and cladding materials can be accommodated.

It is a further object of the present invention to provide a system for lining the interiors and/or exteriors of tubes by laser welding so that the differences between the high points and the low points of the weld are virtually immeasurable.

It is an additional object of the present invention to provide a system for lining tubes using laser welding, in which post-weld machining is virtually eliminated.

It is still another object of the present invention to provide a cladding system for tubes and other similar structures, in which the cladding process can be conducted more far more quickly and thus more economically than in conventional cladding systems.

It is again an additional object of the present invention to provide a laser cladding system for surfaces of tube-like structures, having a simplified optical head, thereby permitting access into smaller interior areas.

It is again a further object of the present invention to provide a system for cladding of tube surfaces in which a smoothing agent is not necessary.

It is still another object of the present invention to provide a system for laser-cladding the surfaces of metal tubes wherein the system is relatively simple to set up compared to conventional systems.

It is again a further object of the present invention to provide a process for laser-cladding the surfaces of metal tube, requiring reduced processing time.

It is still a further object of the present invention to provide a system for lining the surface of a metal tube by laser-welding, wherein the conventional necessity of rotating the laser head is avoided.

It is yet another object of the present invention to provide a uniform, pre-machined surface weld on the surface of a tube-like structure.

It is still a further object of the present invention to provide a system of precisely placing a uniform pattern of anti-abrasive material in a weld melt on the surface of a tube-like structure without melting or otherwise degrading the anti-abrasive material.

It is yet another object of the present invention to provide a cladding process whereby anti-abrasive particle migration can be controlled.

These and other goals and objects of the present invention can be achieved by a welding system for cladding tube-like structures. The system includes a device for rotating the tube-like structure between 100 rpm and 10,000 rpm. A laser welding device is used with an adjustable, fixed optical head. A controller operates to control the rotation of the tube-like structure, coordinating it with the operation of the laser welding device.

Another embodiment of the present invention includes a method of cladding a tube-like structure. Firstly, the tube-like structure is arranged to spin in proximity to a stationary, adjustable laser welding head. The tube-like structure is spun between 100 rpm and 10,000 rpm while the laser welding head is continuously operated to clad the tube-like structure in a continuous uniform weld pattern.

A further embodiment of the present invention includes a tube-like structure having a uniform, non-overlapping welded cladding pattern, where the differences in the thicknesses of the welding pattern are 0.05 inch or less, before post-welding finishing.

### BRIEF DESCRIPTION OF THE DRAWINGS

FIG. 1 is a schematic diagram depicting the various elements in a laser-welding head and auxiliary system as used for the present invention.

FIG. 2 is a schematic diagram depicting one embodiment of the present invention.

FIG. 3 is a side view schematic diagram depicting a support system for a tube to be lined, and the support for the welding equipment to be used to clad the interior of the tube.

### DETAILED DESCRIPTION OF THE PREFERRED EMBODIMENTS

Much of the machinery and other devices used in U.S. Pat. No. 6,486,432 can also be used in the present invention. Accordingly, many of the techniques and equipment of the previous system are provided as examples. However, the present invention is not limited thereto. It should be noted that while all examples show cladding of the interior of a barrel or tube, the present invention can be used to clad the exterior of a tube using the same techniques and machinery.

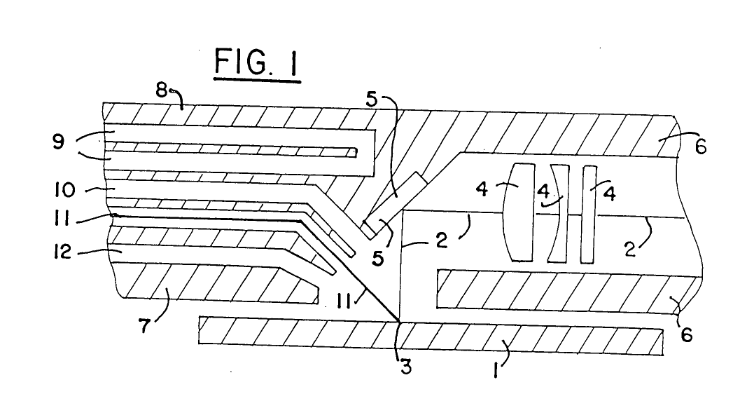

A welding head that can be used with the present invention is depicted in FIG. 1. Welding head 7 includes two major components as depicted in this Figure, laser aiming optics 4, and an auxiliary system (9-12) providing materials to facilitate the welding. These are mounted in housings 6 and 8, respectively. Both housings can be integrally or separately formed, and are placed within a metal tube or barrel 1, in which a lining is to be fabricated by laser-welded cladding. For the sake of simplicity, the other wall of tube 1 is not shown in FIG. 1.

The laser aiming optics 4 of the laser welding head 7 are used to direct laser beam 2 to a point 3 at which a weld is to be placed to form part of the lining in tube 1. The aiming optics 4 includes a lens system and work with a reflecting mirror 5. The aiming optics 4 are contained within a support structure 6, and can either be attached to the auxiliary system housing 8 or separated therefrom. For example, the auxiliary system (9-12) can be separated from the laser aiming optics housing 6 and placed in a separate housing 8. Different configurations for separating the two housings 6, 8 and their components can be used within the scope of the present invention.

The auxiliary system (9-12) is mounted in its own housing or support structure 8, and includes a variety of different elements. Examples of such elements are cooling device 9, a gas supply conduit 10; and, a feeding mechanism 11, which serves to provide cladding material to the weld point 3. An optical system 12 can be added so that the characteristics of the welds and the progress of the welding process can be properly monitored.

Both the auxiliary system housing 8 and the laser aiming optics housing 6 can be supported by conventional bearings (not shown) that serve as an interface between the housings 6, 8 and the metal tube 1. A variety of different support mechanisms and bearings are available, and are generally well known in the conventional art.

One advantage of separating the housing 8 for the auxiliary system from the housing 6 for the laser aiming optics is that these two components can be inserted into metal tube 1 from opposite ends of the tube. The advantage of this is that the two components can be made much smaller than conventional systems, accommodating much smaller inner diameters for the metal tubes, such as plasticating barrels. The present invention can accommodate in inner diameter as small as, or even less than 14 mm.

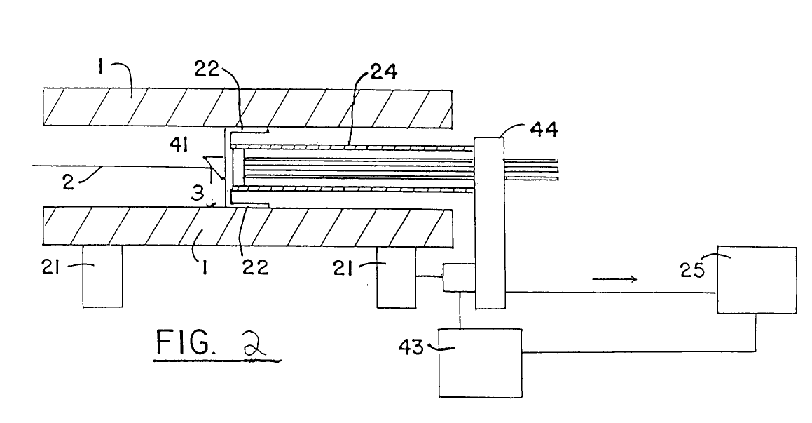

The use of two separate structures for the auxiliary system and the laser aiming optics also produces a much higher level of flexibility than is found with conventional systems. As a result, a wide variety of configurations, such as that depicted in FIG. 2, are possible. However, the present invention is not limited to the embodiments depicted in these two figures but admits to many other variations and equivalents that would occur to one skilled in this technology, once having been taught the present invention.

The miniaturization of both the auxiliary system 9-12 and the laser aiming optics 4 is that ever smaller tubes can be subjected to the cladding system of the present invention. The miniaturization of auxiliary system 9-12 and laser aiming optics 4 is further enhanced by the fact that both of these elements can be rigidly mounted without the need of any movement, even that of a mirror. This is because the tube 1 is the element that is moved throughout the process. It has been found that the mechanical manipulations of the tube are easier to conduct and control than those of the relatively delicate laser welding head. Miniaturization also benefits arrangements of the present invention which are used to clad the exterior of tube-like structures. The smaller, separate components make placement of the arrangement and spinning of the tube much easier and less expensive. Exterior cladding, using the present invention, also takes advantage of easier mechanical manipulation of the tube due to an absence of the cladding equipment within the tube itself.

Mechanical manipulation of tube 1 makes the high speed operation (between 100 and 10,000 rotations per minute) possible in the cladding operations. These high speeds, in turn, result in a far superior finish, in which the variations are minimized and made uniform. The overall manufacturing process from welding to post-weld machining is now much abbreviated with the present invention. The result is a substantial economic advantage when using the high speed rotation of the present invention.

An additional advantage with the separate reduced size structures containing the auxiliary system (9-12) and the laser aiming optics 4, is that additional auxiliary devices can be added to either the auxiliary system housing 8 or the laser aiming optics housing 6. One example is an additional material feed (not shown) that can be used to add anti-abrasive materials, such as metal carbides, to the molten weld material or matrix. Such materials can sink deep into the molten weld matrix lessening the value of the anti-abrasive particles. However, with the flexibility and speed provided by the present invention, anti-abrasive material can be fed to the weld melt as a particular part of the molten weld matrix. The location on the weld where the anti-abrasive particles can be places can be selected so that it is a cooling portion, preventing the particles from sinking deep within the molten material. The speed of the rotation also helps to cool the molten areas more quickly preventing migration of anti-abrasive particles. As a result the anti-abrasive particles will maintain their proper position, and operate efficiently.

The high speed rotation of the tube occurring in the present invention also permits some control over the distribution of anti-abrasive material that is added to the weld. Because the process is conducted so quickly, migration of particles can be halted since the material does not remain molten for a sufficient amount of time to permit migration. The centrifugal force of the rotation can also be used to determine the extent of penetration for these particles if this is considered desirable. In some cases, it may be desirable for additives to migrate all the way through the cladding layer. In many other cases, this is not desirable. The present invention through a wide range of speeds, provides control over the extent of particle migration.

In FIG. 1 the weld point 3 is always at the same position with respect to horizontal and vertical orientation of tube 1. Thus, the laser 2 is always aimed at the same position, and the tube 1 is rotated, at high speeds tube 1 is rotated about a horizontal axis 20 by rollers 21, as depicted in FIG. 2. However, other handling mechanisms can be used rotate tube 1. A controller (not shown) is used to coordinate the rotational movement of tube 1 and operation of laser beam 2 to affect the laser-weld cladding that will constitute the liner of tube 1. Such controllers are already well known in the conventional technology and need no further elaboration for purposes of explaining the present invention.

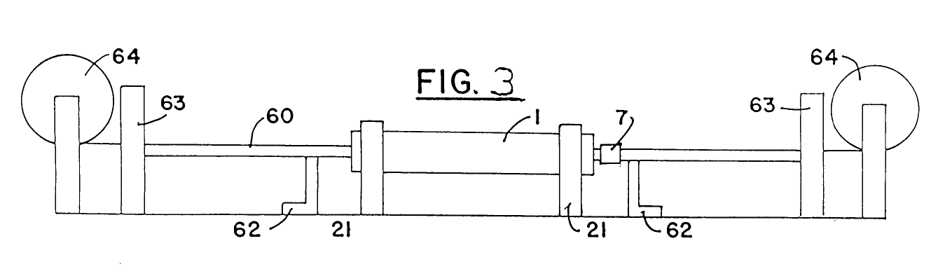

FIG. 3 schematically depicts one example of a system for holding and moving both optical heads 7, 4 and the tube 1 to be lined. Although none of this holding or moving equipment (20, 22, 60-64) is novel, it is an important aspect of the invention since it is responsible for rotating tube 1 at high speed to affect the superior results of the present invention. The welding process is continuous, and is arranged for a rotation speed of between 100 and 10,000 rotations per minute. Currently systems are in operation at 1,500 RPM. The beam width for the weld is approximately one-eighth inch. However, within the concept of the present invention the beam width can be varied.

The result of the high speed rotation with a stationary welding head operating continuously is a very smooth surface, eliminating overlaps and the rolling hill-like structures that are now common in conventional laser welding systems, such as that of U.S. Pat. No. 6,486,432. The rapid rotation of the tube 1 is responsible for a surface that requires virtually no post-weld machining before it can be used for hydraulic cylinders, engine cylinders, pipes and pipe liners, and plasticating barrels. Besides the advantage of a uniform welding pattern, differences in height of the welding patterns are virtually eliminated. The difference between the peaks and valleys is always less than 0.05 inch, very often less than 0.01 inch, and in many cases virtually immeasurable. The relative smoothness permits a very quick and inexpensive post-weld finishing process, 10 to 20 times less than with conventional welding processes.

Conventional laser welding creates a welded cladding in a spiral or helical configuration. With the present invention, this spiral configuration is all but undetectable because of the high speed rotation of tube 1 and the movement of the tube along a horizontal axis with respect to the stationary weld head. The coordination of these two movements is handled by a controller (not shown). The programming of the controller can be provided by standard programming techniques accommodate the substantially higher rotational speed of, which need modification only to the present invention.

Because the controller can be programmed to accommodate operation of speeds at 10,000 RPM and greater for the rotating tube-like structure, the time to conduct the cladding process is greatly reduced in comparison with that of conventional systems. Further, because post cladding machining is almost entirely eliminated, substantial time is also saved in the post welding operations. This means that there is a greatly reduced manufacturing time and accompanying cost savings as a result. A reduction in the time and effort required for post-weld machining is particularly significant.

While the drawings depict one arrangement of the present invention whereby the inventive process can be carried out to achieve inventive pre-machined welded surface, other arrangements can be used within the concept of the present invention. The orientation of the rotating tube and the stationary laser welding head can be adjusted for optimal operation and speed. The adjustment can also be made to accommodate cladding on the exterior surface of the tube, as well as the interior. Further, adjustments can be made so that flanges and other edge structures of the tube can also be cladded. One skilled in this particular technology will be able to set up the appropriate variations of the inventive system is accordance with the high speeds being used on a particular type of surface to be cladded. Accordingly, almost any variation in the high speed rotating system is in the present invention.

In the alternative, the laser aiming optics housing 6 and the auxiliary equipment housing 8 can be mounted on sled 22 and moved through the tube 1 using linear motion system 25 as depicted in FIG. 2. The operation of the linear motion system 25 to coordinate with the welding operation requires no special expertise beyond skill already available in this technology. If the laser aiming optics housing 6 is not connected to the auxiliary system housing 8, an additional linear motion system will be necessary to move the auxiliary system housing 8 in coordination with the movement of the laser aiming optics housing 6. This would incur additional complexity and expense Any number or variety of mirror sizes and shapes can be used to direct the laser beam 2 to a specific point on the interior of tube 1 (or any other shape of interior surface), and the adjustability of both mirror size and shape easily facilitates converting the welding system from one tube size to another. Further, while the laser beam 2 is donut-shaped, the laser beam 2 can be configured in any manner deemed appropriate for the desired weld configuration. Accordingly, any size or shape of the mirror can also be used to facilitate a desired weld pattern, or other laser-weld characteristics.

While each of the preferred embodiments of the present invention has been directed to the lining of a steel (or steel alloy) plasticating barrels, other metal tubes can be lined using the various embodiments or any combination thereof of the previously-described invention. Also, other materials can be applied (either internally or externally) using the techniques of the present invention in any number of variations of the preferred embodiments described herein. For example, any type of metallic tube can be used, as well as plastic or “Kevlar®” in the inventive cladding process. Further, the lining material need not be the popular nickel-chromium blend. Rather, other materials can be used as is appropriate with the tube substrate.

While a number of embodiments and variations have been made by way of example, the present invention is not to be limited thereby. Rather, the present invention should be construed to include any and all modifications, permutations, variations, adaptations and embodiments that would occur to one skilled in this technology once taught the present invention by this application. Accordingly, the present invention should be considered as being limited only by the following claims.

1. A welding system for cladding tube-like structures, comprising:
(a) means for rotating said tube-like structure between 100 rpm and 10,000 rpm;
(b) a laser welding device having an adjustable, fixed optical head; and,
(c) a controller having means for controlling rotation of said tube-like structure and coordinating operation of said laser welding device.

2. The welding system of claim 1, wherein said controller operates so that said laser welding device produces a continuously uniform weld pattern.

3. The welding system of claim 2, wherein said means for rotating said tube-like structure operates at 100-2000 rpm.

4. The welding system of claim 2, wherein said laser welding device is positioned for cladding an interior surface of said tube-like structure.

5. The welding system of claim 2, wherein said laser welding device is positioned for cladding an external surface of said tube-like structure.

6. A method of cladding a tube-like structure, comprising the steps of:
(a) arranging said tube-like structure to spin in proximity to a stationary, adjustable laser welding head;
(b) spinning said tube-like structure between 100 rpm and 10,000 rpm; and,
(c) continuously operating said laser welding head to clad said tube-like structure in a continuous uniform weld pattern.

7. The method of claim 6, wherein said metallic tube-like structure rotates at 100-2000 rpm.

8. The method of claim 6, wherein said laser welding head produces a laser beam having a width of 1/16-¼ inch.

9. The method of claim 6, further comprising the step of:
(d) adding anti-abrasive particulate matter during said continuous operation of said laser welder while controlling speed of rotation of said tub-like structure to place said particulate matter within said continuous weld.

10. The method of claim 6, wherein said tube-like structure is metallic.

11. The method of claim 6, wherein cladding is carried out on an internal surface
of said tube-like structure.

12. The method of claim 6, wherein cladding is carried out on an external
surface of said tube-like structure.

13. A tube-like structure having a uniform, non-overlapping welded cladding
pattern, wherein differences in thicknesses of said cladding pattern are 0.05 inch or less, before application of post-welding finishing.

14. Tube-like structure of claim 13, wherein said tube-like structure is metallic.

15. The tube-like structure of claim 14, wherein said cladding is created by laser
welding.

16. The tube-like structure of claim 15, wherein said differences in thicknesses
of said uniform welded cladding pattern are 0.01 inch or less.

17. The tube-like structure of claim 15, wherein said uniform welded cladding pattern is on an exterior of said tube-like structure.

18. The tube-like structure of claim 15, wherein said uniform welded cladding pattern is on an interior of said tube-like structure.
